(19) United States
(12) Patent Application Publication
(10) Pub. No.: US 2020/0210244 A1
(43) Pub. Date: Jul. 2, 2020

(54) VIRTUAL RESOURCE PLACEMENT

(71) Applicant: Nokia Solutions and Networks Oy, Espoo (FI)

(72) Inventors: Gil Einziger, Elishama (IL); Maayan Goldstein, Tikva (IL); Yaniv Sa'ar, Tel-mond (IL); Erez Waisbard, Ramat-Gan (IL)

(21) Appl. No.: 16/236,620

(22) Filed: Dec. 30, 2018

(51) Int. Cl. G06F 9/50; G06F 9/52

(52) U.S. Cl. CPC G06F 9/5077; G06F 2209/501; G06F 9/52

(57) ABSTRACT

Various example embodiments for supporting placement of virtual resources in a resource virtualization system are presented. The resource virtualization system may include a set of hosts configured to host virtual resources based on underlying physical resources and a set of schedulers configured to receive and handle requests for virtual resources. The handling of requests for virtual resources by the schedulers may include selecting ones of the hosts to handle the requests for virtual resources and initiating instantiation of the virtual resources on the ones of the hosts selected to handle the requests for virtual resources. The selection of the ones of the hosts to handle the requests for virtual resources may be performed by the schedulers using groups of hosts that include subsets of the hosts of the resource virtualization system.

### TECHNICAL FIELD

Various example embodiments relate generally to resource placement and, more particularly but not exclusively, to supporting virtual resource placement in a resource virtualization system.

### BACKGROUND

Resource virtualization systems typically include virtualization servers configured to support virtual resources based on underlying physical resources of the virtualization servers.

### SUMMARY

In at least some example embodiments, an apparatus includes at least one processor and at least one memory including computer program code, wherein the at least one memory and the computer program code are configured to, with the at least one processor, cause the apparatus to at least determine, by a scheduler from a set of available hosts responsive to a request for a virtual resource, a group of hosts including a subset of the available hosts, obtain, by the scheduler for each of the hosts in the group of hosts, respective state information associated with the respective host, and select, by the scheduler from the group of hosts based on the state information associated with the hosts, one of the hosts to serve the request for the virtual resource. In at least some example embodiments, the group of hosts is determined by the scheduler based on selection of the group of hosts by the scheduler. In at least some example embodiments, the group of hosts is determined by the scheduler based on a message from a controller. In at least some example embodiments, the group of hosts is a random subset of the available hosts. In at least some example embodiments, a quantity of hosts in the group of hosts is based on a quantity of schedulers configured to operate on the set of available hosts. In at least some example embodiments, a quantity of hosts in the group of hosts is based on a virtual resource placement success rate. In at least some example embodiments, the group of hosts is mutually disjoint from a second group of hosts associated with a second scheduler. In at least some example embodiments, the scheduler is configured to operate without synchronziation with the second scheduler. In at least some example embodiments, the group of hosts at least partially overlaps a second group of hosts associated with a second scheduler. In at least some example embodiments, the scheduler is configured to operate without synchronziation with the second scheduler. In at least some example embodiments, the scheduler is configured to operate based on synchronization with the second scheduler in a manner for preventing the scheduler and the second scheduler from selecting a common host. In at least some example embodiments, the one of the hosts selected to serve the request for the virtual resource is a least-loaded host in the group of hosts or a lowest-latency host in the group of hosts. In at least some example embodiments, the at least one memory and the computer program code are configured to, with the at least one processor, cause the apparatus to at least initiate, by the scheduler, placement of the virtual resource on the one of the hosts selected to serve the request for the virtual resource. In at least some example embodiments, to initiate placement of the virtual resource on the one of the hosts selected to serve the request for the virtual resource, the at least one memory and the computer program code are configured to, with the at least one processor, cause the apparatus to at least send, by the scheduler toward the one of the hosts selected to serve the request for the virtual resource, a message requesting placement of the virtual resource on the one of the hosts selected to serve the request for the virtual resource. In at least some example embodiments, to initiate placement of the virtual resource on the one of the hosts selected to serve the request for the virtual resource, the at least one memory and the computer program code are configured to, with the at least one processor, cause the apparatus to at least send, by the scheduler toward a controller, a message requesting placement of the virtual resource on the one of the hosts selected to serve the request for the virtual resource. In at least some example embodiments, the at least one memory and the computer program code are configured to, with the at least one processor, cause the apparatus to at least initiate, by the scheduler based on a determination that placement of the virtual resource on the one of the hosts selected to serve the request for the virtual resource is not successful, a new attempt to serve the request for the virtual resource. In at least some example embodiments, the new attempt to serve the request for the virtual resource is based on one of the group of hosts, a new group of hosts having a size equal to a size of the group of hosts, or a new group of hosts having a size larger than a size of the group of hosts. In at least some example embodiments, the virtual resource comprises a virtual machine or a virtual container.

In at least some example embodiments, a non-transitory computer-readable medium includes instructions configured to cause an apparatus to at least determine, by a scheduler from a set of available hosts responsive to a request for a virtual resource, a group of hosts including a subset of the available hosts, obtain, by the scheduler for each of the hosts in the group of hosts, respective state information associated with the respective host, and select, by the scheduler from the group of hosts based on the state information associated with the hosts, one of the hosts to serve the request for the virtual resource. In at least some example embodiments, the group of hosts is determined by the scheduler based on selection of the group of hosts by the scheduler. In at least some example embodiments, the group of hosts is determined by the scheduler based on a message from a controller. In at least some example embodiments, the group of hosts is a random subset of the available hosts. In at least some example embodiments, a quantity of hosts in the group of hosts is based on a quantity of schedulers configured to operate on the set of available hosts. In at least some example embodiments, a quantity of hosts in the group of hosts is based on a virtual resource placement success rate. In at least some example embodiments, the group of hosts is mutually disjoint from a second group of hosts associated with a second scheduler. In at least some example embodiments, the scheduler is configured to operate without synchronziation with the second scheduler. In at least some example embodiments, the group of hosts at least partially overlaps a second group of hosts associated with a second scheduler. In at least some example embodiments, the scheduler is configured to operate without synchronziation with the second scheduler. In at least some example embodiments, the scheduler is configured to operate based on synchronization with the second scheduler in a manner for preventing the scheduler and the second scheduler from selecting a common host. In at least some example embodiments, the one of the hosts selected to serve the request for the virtual resource is a least-loaded host in the group of hosts or a lowest-latency host in the group of hosts. In at least some example embodiments, the non-transitory computer-readable medium includes instructions configured to cause the apparatus to at least initiate, by the scheduler, placement of the virtual resource on the one of the hosts selected to serve the request for the virtual resource. In at least some example embodiments, to initiate placement of the virtual resource on the one of the hosts selected to serve the request for the virtual resource, the non-transitory computer-readable medium includes instructions configured to cause the apparatus to at least send, by the scheduler toward the one of the hosts selected to serve the request for the virtual resource, a message requesting placement of the virtual resource on the one of the hosts selected to serve the request for the virtual resource. In at least some example embodiments, to initiate placement of the virtual resource on the one of the hosts selected to serve the request for the virtual resource, the non-transitory computer-readable medium includes instructions configured to cause the apparatus to at least send, by the scheduler toward a controller, a message requesting placement of the virtual resource on the one of the hosts selected to serve the request for the virtual resource. In at least some example embodiments, the non-transitory computer-readable medium includes instructions configured to cause the apparatus to at least initiate, by the scheduler based on a determination that placement of the virtual resource on the one of the hosts selected to serve the request for the virtual resource is not successful, a new attempt to serve the request for the virtual resource. In at least some example embodiments, the new attempt to serve the request for the virtual resource is based on one of the group of hosts, a new group of hosts having a size equal to a size of the group of hosts, or a new group of hosts having a size larger than a size of the group of hosts. In at least some example embodiments, the virtual resource comprises a virtual machine or a virtual container.

In at least some example embodiments, a method includes determining, by a scheduler from a set of available hosts responsive to a request for a virtual resource, a group of hosts including a subset of the available hosts, obtaining, by the scheduler for each of the hosts in the group of hosts, respective state information associated with the respective host, and selecting, by the scheduler from the group of hosts based on the state information associated with the hosts, one of the hosts to serve the request for the virtual resource. In at least some example embodiments, the group of hosts is determined by the scheduler based on selection of the group of hosts by the scheduler. In at least some example embodiments, the group of hosts is determined by the scheduler based on a message from a controller. In at least some example embodiments, the group of hosts is a random subset of the available hosts. In at least some example embodiments, a quantity of hosts in the group of hosts is based on a quantity of schedulers configured to operate on the set of available hosts. In at least some example embodiments, a quantity of hosts in the group of hosts is based on a virtual resource placement success rate. In at least some example embodiments, the group of hosts is mutually disjoint from a second group of hosts associated with a second scheduler. In at least some example embodiments, the scheduler is configured to operate without synchronziation with the second scheduler. In at least some example embodiments, the group of hosts at least partially overlaps a second group of hosts associated with a second scheduler. In at least some example embodiments, the scheduler is configured to operate without synchronziation with the second scheduler. In at least some example embodiments, the scheduler is configured to operate based on synchronization with the second scheduler in a manner for preventing the scheduler and the second scheduler from selecting a common host. In at least some example embodiments, the one of the hosts selected to serve the request for the virtual resource is a least-loaded host in the group of hosts or a lowest-latency host in the group of hosts. In at least some example embodiments, the method includes initiating, by the scheduler, placement of the virtual resource on the one of the hosts selected to serve the request for the virtual resource. In at least some example embodiments, initiating placement of the virtual resource on the one of the hosts selected to serve the request for the virtual resource includes sending, by the scheduler toward the one of the hosts selected to serve the request for the virtual resource, a message requesting placement of the virtual resource on the one of the hosts selected to serve the request for the virtual resource. In at least some example embodiments, initiating placement of the virtual resource on the one of the hosts selected to serve the request for the virtual resource includes sending, by the scheduler toward a controller, a message requesting placement of the virtual resource on the one of the hosts selected to serve the request for the virtual resource. In at least some example embodiments, the method includes initiating, by the scheduler based on a determination that placement of the virtual resource on the one of the hosts selected to serve the request for the virtual resource is not successful, a new attempt to serve the request for the virtual resource. In at least some example embodiments, the new attempt to serve the request for the virtual resource is based on one of the group of hosts, a new group of hosts having a size equal to a size of the group of hosts, or a new group of hosts having a size larger than a size of the group of hosts. In at least some example embodiments, the virtual resource comprises a virtual machine or a virtual container.

In at least some example embodiments, an apparatus includes means for determining, by a scheduler from a set of available hosts responsive to a request for a virtual resource, a group of hosts including a subset of the available hosts, means for obtaining, by the scheduler for each of the hosts in the group of hosts, respective state information associated with the respective host, and means for selecting, by the scheduler from the group of hosts based on the state information associated with the hosts, one of the hosts to serve the request for the virtual resource. In at least some example embodiments, the group of hosts is determined by the scheduler based on selection of the group of hosts by the scheduler. In at least some example embodiments, the group of hosts is determined by the scheduler based on a message from a controller. In at least some example embodiments, the group of hosts is a random subset of the available hosts. In at least some example embodiments, a quantity of hosts in the group of hosts is based on a quantity of schedulers configured to operate on the set of available hosts. In at least some example embodiments, a quantity of hosts in the group of hosts is based on a virtual resource placement success rate. In at least some example embodiments, the group of hosts is mutually disjoint from a second group of hosts associated with a second scheduler. In at least some example embodiments, the scheduler is configured to operate without synchronziation with the second scheduler. In at least some example embodiments, the group of hosts at least partially overlaps a second group of hosts associated with a second scheduler. In at least some example embodiments, the scheduler is configured to operate without synchronziation with the second scheduler. In at least some example embodiments, the scheduler is configured to operate based on synchronization with the second scheduler in a manner for preventing the scheduler and the second scheduler from selecting a common host. In at least some example embodiments, the one of the hosts selected to serve the request for the virtual resource is a least-loaded host in the group of hosts or a lowest-latency host in the group of hosts. In at least some example embodiments, the apparatus includes means for initiating, by the scheduler, placement of the virtual resource on the one of the hosts selected to serve the request for the virtual resource. In at least some example embodiments, the means for initiating placement of the virtual resource on the one of the hosts selected to serve the request for the virtual resource includes means for sending, by the scheduler toward the one of the hosts selected to serve the request for the virtual resource, a message requesting placement of the virtual resource on the one of the hosts selected to serve the request for the virtual resource. In at least some example embodiments, the means for initiating placement of the virtual resource on the one of the hosts selected to serve the request for the virtual resource includes means for sending, by the scheduler toward a controller, a message requesting placement of the virtual resource on the one of the hosts selected to serve the request for the virtual resource. In at least some example embodiments, the apparatus includes means for initiating, by the scheduler based on a determination that placement of the virtual resource on the one of the hosts selected to serve the request for the virtual resource is not successful, a new attempt to serve the request for the virtual resource. In at least some example embodiments, the new attempt to serve the request for the virtual resource is based on one of the group of hosts, a new group of hosts having a size equal to a size of the group of hosts, or a new group of hosts having a size larger than a size of the group of hosts. In at least some example embodiments, the virtual resource comprises a virtual machine or a virtual container.

### BRIEF DESCRIPTION OF THE DRAWINGS

The teachings herein can be readily understood by considering the following detailed description in conjunction with the accompanying drawings, in which:

FIG. 1 depicts an example embodiment of a resource virtualization system configured to support virtual resources;

FIG. 2 depicts an example of a resource virtualization system configured to support virtual resources;

FIG. 3 depicts an example embodiment of a method for use by a scheduler to select a host to serve a request for a virtual resource; and

FIG. 4 depicts a high-level block diagram of a computer suitable for use in performing various functions presented herein.

To facilitate understanding, identical reference numerals have been used, where possible, to designate identical elements that are common to the figures.

### DETAILED DESCRIPTION

Various example embodiments for supporting placement of virtual resources in a resource virtualization system are presented. The resource virtualization system may include a set of hosts configured to host virtual resources based on underlying physical resources and a set of schedulers configured to receive and handle requests for virtual resources. The handling of requests for virtual resources by the schedulers may include selecting ones of the hosts to handle the requests for virtual resources and initiating instantiation of the virtual resources on the ones of the hosts selected to handle the requests for virtual resources. The selection of the ones of the hosts to handle the requests for virtual resources may be performed by the schedulers using groups of hosts that include subsets of the hosts of the resource virtualization system. The selection of one of the hosts to handle a request for virtual resources received by a given scheduler may include determining a group of hosts that includes a subset of the hosts of the resource virtualization system, obtaining state information for each of the hosts in the group of hosts, and selecting, from the group of hosts based on the state information for the hosts in the group of hosts, one of the hosts to serve the request for virtual resources received by the given scheduler. It is noted that selection of the subset of hosts as candidates to handle the request for virtual resources may provide various advantages or potential advantages (e.g., reducing the amount of state information that is obtained and analyzed in order to select the one of the hosts to serve the request for virtual resources, improving latency and other parameters associated with handling of request for virtual resources, or the like). The given scheduler may then initiate placement of the virtual resource on the one of the hosts selected to serve the request for the virtual resource. Various example embodiments may be configured to provide efficient handling of a request for virtual resources, based on efficient state information sampling using state information queries on a subset of the available hosts rather than on all of the available hosts, while still achieving a reasonably good virtual resource placement that meets associated placement requirements (e.g., service level agreements or other requirements). Various example embodiments may be configured to provide efficient handling of requests for virtual resources in a system including a set of available hosts, based on efficient state information sampling using state information queries on subsets of the available hosts rather than all of the available hosts for given virtual resource requests, by carefully setting the number of schedulers and the associated subgroup sizes (and, therefore, the number of state information queries) for the schedulers. It will be appreciated that the resource virtualization system, which also may be referred to herein as a cloud system supporting cloud resources, may be any suitable type of resource virtualization system (e.g., a datacenter, a service provider system, a server, or the like), the virtual resources may include various types of virtual resources (e.g., virtual machines, virtual containers, or the like, as well as various combinations thereof), or the like, as well as various combinations thereof. It will be appreciated that these and various other example embodiments and advantages or potential advantages of supporting placement of virtual resources in a resource virtualization system may be further understood by way of reference to the various figures, which are discussed further below.

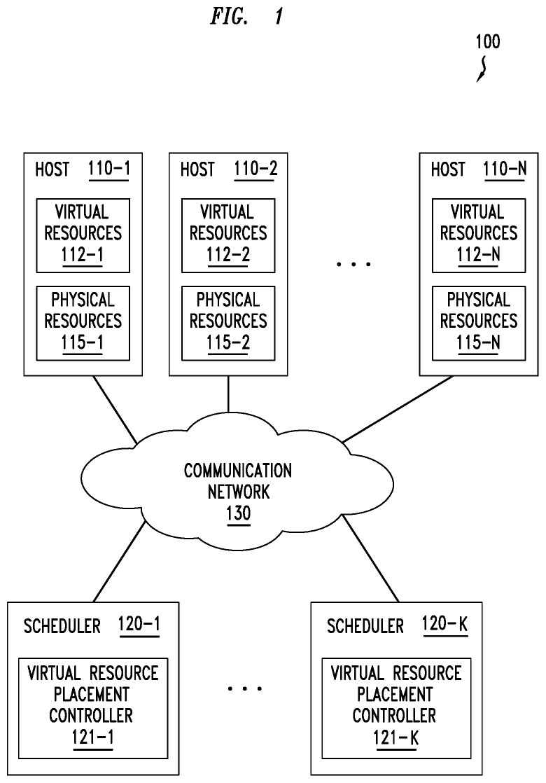

FIG. 1 depicts an example embodiment of a resource virtualization system configured to support virtual resources.

The resource virtualization system 100 may be any suitable type of system which may support virtual resources based on underlying physical resources. For example, the resource virtualization system 100 may be a datacenter, a service provider system, a server, or the like.

The resource virtualization system 100 includes a set of hosts 110-1-110-N (collectively, hosts 110), a set of schedulers 120-1-120-K (collectively, schedulers 120), and a communication network 130. The hosts 110 may be configured to communicate with each other and with schedulers 120 via the communication network 130. The schedulers 120 may be configured to communicate with each other and with the hosts 110 via the communication network 130. It will be appreciated that the resource virtualization system 100 may include various other elements (e.g., control elements configured to control the hosts 110 and the schedulers 120, communication elements configured to support communications between the hosts 110 and the schedulers 120, or the like, as well as various combinations thereof), which have been omitted from FIG. 1 for purposes of clarity.

The hosts 110 are configured to host virtual resources 112 based on underlying physical resources 115 (illustratively, hosts 110-1-110-N host virtual resources 112-1-112-N based on underlying physical resources 115-1-115-N of the hosts 110-1-110-N, respectively). For example, virtual resources 112 which may be hosted by the hosts 110 may include virtual processor resources, virtual memory resources, virtual storage resources, virtual networking resources, virtual machines, virtual containers, or the like, as well as various combinations thereof. For example, physical resources 115 of the hosts 110 which may support hosting of virtual resources 112 by the hosts 110 may include processors, memories, storage resources, input-output resources, or the like, as well as various combinations thereof. The hosts 110 may include various other elements (omitted from FIG. 1 for purposes of clarity) configured to support hosting of the virtual resources 112 based on the underlying physical resources 115.

The schedulers 120 are configured to support handling of requests for virtual resources using the hosts 110, including supporting placement of virtual resources on hosts 110 responsive to requests for virtual resources. The schedulers 120 may support placement of virtual resources on hosts 110 responsive to requests for virtual resources by receiving the requests for virtual resources and assigning the requests for virtual resources to hosts 110 for instantiation of the virtual resources on the hosts 110 (as part of the virtual resources 112 which are supported using the underlying physical resources 115). The schedulers 120 may include virtual resource placement controllers 121 (illustratively, schedulers 120-1-120-K include virtual resource placement controllers 121-1-121-K, respectively) configured to control placement of virtual resources on hosts 110 responsive to requests for virtual resources. The schedulers 120 may include various other elements (omitted from FIG. 1 for purposes of clarity) configured to support handling of requests for virtual resources using the hosts 110.

The schedulers 120, as indicated above, are configured to receive requests for virtual resources and to assign the requests for virtual resources to hosts 110 for instantiation of the virtual resources on the hosts 110. The schedulers 120 are configured to assign requests for virtual resources to hosts 110 by selecting ones of the hosts 110 for the requests for virtual resources and assigning the requests for virtual resources to the selected ones of the hosts 110 for instantiation of the virtual resources on the selected ones of the hosts 110. In general, a scheduler 120 that receives a request for a virtual resource may select one of the hosts 110 to serve the request for the virtual resource by determining a group of hosts 110 that includes a subset of the hosts 110, obtaining state information for each of the hosts 110 in the group of hosts 110, and selecting, based on the state information for the hosts 110 in the group of hosts 110, one of the hosts 110 in the group of hosts 110 as the selected one of the hosts 110 to serve the request for the virtual resource. The use of a subset of the hosts 110 as candidates to serve the request for the virtual resource, rather than considering each of the available hosts 110 as candidates to serve the request for the virtual resource, obviates the need for the scheduler 120 to obtain and analyze state information for each of the available hosts 110.

The schedulers 120 receive the requests for virtual resources. The schedulers 120 may receive requests for virtual resources that may originate from various sources, such as requests by customers for instantiation of virtual resources within resource virtualization system 100, requests by devices or elements (e.g., device or elements internal to resource virtualization system 100, devices or elements external to resource virtualization system 100, or the like) for instantiation of virtual resources within resource virtualization system 100, or the like, as well as various combinations thereof. The schedulers 120 may receive requests for virtual resources that may be requests for various types of virtual resources (e.g., requests for virtual machines, virtual containers, or the like, as well as various combinations thereof). The schedulers 120 may receive the requests for virtual resources from a front-end element (which has been omitted from FIG. 1 for purposes of clarity) that is configured to receive the requests for virtual resources and to provide the requests for virtual resources to the schedulers 120 for handling of the requests for virtual resources by the schedulers 120 (e.g., a front-end controller, load balancer, or the like). The schedulers 120 may be configured to receive requests for virtual resources in various other ways.

The schedulers 120 determine subsets of the hosts 110 that are candidates to serve requests for virtual resources. A scheduler 120 may determine a subset of the hosts 110 that are candidates to serve a request for virtual resources responsive to, or otherwise in conjunction with, receipt of the request for virtual resources at the scheduler 120. The subset of the hosts 110 that are candidates to serve a request for virtual resources may be specific to the request for virtual resources (e.g., where the subset of the hosts 110 that are candidates to serve a request for virtual resources may vary across each request for virtual resources received by the associated scheduler 120) or may be specific to a group of requests for virtual resources (e.g., where the subset of the hosts 110 that are candidates to serve a request for virtual resources may be persistent across multiple requests for virtual resources received by the associated scheduler 120). The subset of hosts 110 that are candidates to serve a request for virtual resources includes less than all of the available hosts 110 (i.e., less than N). The subset of the hosts 110 that are candidates to serve a request for virtual resources may be randomly selected (e.g., a random sample having a sample size S).

The schedulers 120 determine subsets of the hosts 110 that are candidates to serve requests for virtual resources in various ways. A scheduler 120 may determine the subset of the hosts 110 that are candidates to serve a request for virtual resources by receiving an indication of the subset of hosts 110 from a controller configured to provide control functions for the scheduler 120 (e.g., where the controller may select the subset of hosts 110 on behalf of the scheduler 120 and an indication of the subset of hosts 110 selected for the scheduler 120 may be provided to the scheduler 120 by the controller when the controller knows that the request for the virtual resource has been provided to the scheduler 120, responsive to a request received from the scheduler 120, or the like). A scheduler 120 may determine the subset of the hosts 110 that are candidates to serve a request for virtual resources by selecting the subset of hosts 110 locally at the scheduler 120 (e.g., randomly, based on a selection algorithm, or the like). A scheduler 120 may determine the subset of the hosts 110 that are candidates to serve a request for virtual resources in various other ways.

The schedulers 120, as indicated above, determine subsets of the hosts 110 that are candidates to serve requests for virtual resources. The subsets of hosts 110 that are candidates to serve requests for virtual resources being handled by schedulers 120 may vary, for individual schedulers 120 and across schedulers 120, in various ways. The subsets of hosts 110 may vary in terms of the quantities of hosts 110 included in the subsets of hosts 110, the specific ones of the hosts 110 included in the subsets of hosts 110, or the like, as well as various combinations thereof. The subsets of hosts 110 may vary over various scales (e.g., changing with each request for virtual resources, changing across blocks of requests for virtual resources, changing over various time scales, or the like). The subsets of hosts 110 may vary responsive to various conditions (e.g., instantiation of one or more new hosts 110, termination of one or more existing hosts 110, instantiation of one or more new schedulers 120, termination of one or more existing schedulers 120, or the like). The subsets of hosts 110 may vary in various other ways.

The subsets of hosts 110 that are candidates to serve requests for virtual resources being handled by schedulers 120, as indicated above, may be fixed or may vary for individual schedulers 120. For example, for a given scheduler 120, the respective subsets of hosts 110 for respective requests for virtual resources received by the scheduler 120 may be fixed and/or dynamic (e.g., in terms of quantities of hosts 110, ones of the hosts 110 included in the subset of hosts 110, or the like) over various scales, based on various conditions, or the like, as well as various combinations thereof. For example, for a given scheduler 120, the respective subsets of hosts 110 for respective requests for virtual resources received by the scheduler 120 may include the same quantity of hosts 110 across requests with random selection of hosts 110 for inclusion in the subset for each of the respective requests, different quantity of hosts 110 across requests with random selection of hosts 110 for inclusion in the subset for each of the respective requests, or the like. The selection of subsets of hosts 110 for a particular scheduler 120 may be performed in various other ways.

The subsets of hosts 110 that are candidates to serve requests for virtual resources being handled by schedulers 120, as indicated above, may be fixed or may vary across schedulers 120. For example, each of the schedulers 120 may be configured to use the same quantity of hosts 110 in the respective subsets of hosts 110 determined for the schedulers 120, different ones of the schedulers 120 may be configured to use different quantity of hosts 110 in the respective subsets of hosts 110 determined for the schedulers 120, or the like. For example, each of the schedulers 120 may be configured to modify one or more aspects of the respective subsets of hosts 110 determined for the schedulers 120 for each request for virtual resources, across blocks of requests for virtual resources, or the like. The selection of subsets of hosts 110 across schedulers 120 may be performed in various other ways.

The subsets of hosts 110 determined by the schedulers 120, as indicted above, may vary in terms of the quantities of hosts 110 included in the subsets of hosts 110. The quantities of hosts 110 included in the respective subsets of hosts 110 for the schedulers 120 may be adaptively determined and modified according to the virtual resource placement success rate (e.g., reduce the sample size when the virtual resource placement success rate is high, and increase the sample size when the virtual resource placement success rate is low). It will be appreciated that the quantities of hosts 110 included in the respective subsets of hosts 110 for the schedulers 120 may be managed (e.g., determined, modified, or the like) in various other ways.

The subsets of hosts 110 determined by the schedulers 120, as indicted above, may vary in terms of the specific ones of the hosts 110 included in the subsets of hosts 110. The subsets of the hosts 110 that are candidates to serve requests for virtual resources received by the schedulers 120 may be mutually exclusive for at least a portion of the schedulers 120 (e.g., between certain pairs of schedulers 120, between all schedulers 120, or the like) or may be at least partially overlapping for at least a portion of the schedulers 120 (e.g., depending on the numbers of hosts 110 in the subsets of hosts 110, the manner in which the subsets of hosts 110 are selected, or the like, as well as various combinations thereof). It will be appreciated that the ones of the hosts 110 included in the respective subsets of hosts 110 for the schedulers 120 may be managed (e.g., determined, modified, or the like) in various other ways. It is noted, as discussed further below, that the manner in which the schedulers 120 operate may depend on whether or not the subsets of the hosts 110 for the schedulers 120 are mutually exclusive or at least partially overlapping.

The schedulers 120 may operate independently, without any synchronization therebetween, when the subsets of the hosts 110 that are candidates to serve requests for virtual resources received by the schedulers 120 are constrained to be mutually exclusive (e.g., where a controller ensures that different subsets of hosts 110 are assigned to different schedulers 120, where a host selection algorithm executed by the schedulers 120 is configured to prevent overlap between subsets of hosts 110 that are assigned to different schedulers 120, or the like). It is noted that the use of mutually exclusive groups of hosts 110 by the schedulers 120 results in double-blind placement of virtual resources between any given pair of schedulers 120. In this case, in which the groups of hosts 110 used by the schedulers 120 are mutually exclusive, it will be known that there will not be any collisions between multiple schedulers 120 on the same hosts 110 and, as a result the operation of a given scheduler 120 cannot affect the placement results of other schedulers 120. It is noted that such embodiments support parallelism between the schedulers 120, enabling the schedulers to sample the hosts 110 in parallel to reach placement decisions for different requests for virtual resources in parallel.

The schedulers 120 may operate independently, without any synchronization therebetween, when the subsets of the hosts 110 that are candidates to serve requests for virtual resources received by the schedulers 120 are not constrained to be mutually exclusive. Here, the risk of collisions by different schedulers 120 on the same host 110 may vary, depending on factors such as the number of hosts 110 available, the number of hosts 110 in the overlapping subsets of hosts 110, the amount of overlap in the overlapping subsets of hosts 110, or the like, as well as various combinations thereof. The risk of collisions by different schedulers 120 on the same host 110 decreases with an increase in the number of hosts 110 and may be relatively low based on the “birthday paradox” (e.g., even with only a couple of dozens schedulers 120, the probability for interference between schedulers 120 is relatively low). The risk of collisions by different schedulers 120 on the same host 110 may be handled in various ways, which may or may not depend on the level of risk of collisions by different schedulers 120 on the same host 110. For example, the risk of collisions by different schedulers 120 on the same host 110 due to overlapping subsets of hosts 110 may be handled, without supporting synchronization between schedulers 120, by supporting exception handling which enables detection and handling of collisions if and when such collisions actually occur. For example, the risk of collisions by different schedulers 120 on the same host 110 due to overlapping subsets of hosts 110 may be handled by supporting synchronization between schedulers 120 (e.g., where the schedulers 120 communicate with each other directly or indirectly through an intermediary in order to prevent collisions, where the schedulers 120 communicate with a controller that prevents collisions, or the like) which enables the schedulers 120 to select ones of the hosts 110 in the respective subsets of hosts 110 in a way that prevents collisions by the different schedulers 120 on the same host 110. This synchronization between schedulers 120 may be always enabled, may be dynamically enabled and disabled for all schedulers 120 or between specific combinations of schedulers 120 (e.g., enabled where the risk of a collision between by schedulers 120 on the same host 110 rises above a threshold and disabled where the risk of a collision between by schedulers 120 on the same host 110 rises falls below a threshold), or the like, as well as various combinations thereof. It is noted that such embodiments support parallelism between the schedulers 120, enabling the schedulers to sample the hosts 110 in parallel to reach placement decisions for different requests for virtual resources in parallel.

The schedulers 120 may obtain the state information for the hosts 110 in the subset of hosts 110 in various ways. The state information for a host 110 may include the load on the host 110, a latency of the host 110, or the like, as well as various combinations thereof. The schedulers 120 may retrieve the state information for the hosts 110 in the subset of hosts 110 by retrieving the state information from the hosts 110 in the subset of hosts 110 (e.g., sending requests for state information to the hosts 110 in the subset of hosts 110 and receiving corresponding state information response messages including state information from the hosts 110 in the subset of hosts 110). The schedulers 120 may retrieve the state information for the hosts 110 in the subset of hosts 110 by retrieving the state information from cached state information of the hosts 110 in the subset of hosts 110 (e.g., sending requests for cached state information of the hosts 110 in the subset of hosts 110 and receiving corresponding state information response messages including cached state information of the hosts 110 in the subset of hosts 110). The schedulers 120 may obtain the state information for the hosts 110 in the subset of hosts 110 in various other ways.

The schedulers 120 may select, based on the state information for the hosts 110 in the subsets of hosts 110, ones of the hosts 110 in the subsets of hosts 110 as the selected ones of the hosts 110 to serve the requests for virtual resources received by the schedulers 120. The schedulers 120 may select ones of the hosts 110 in the subsets of hosts 110 as the selected ones of the hosts 110 to serve the requests for virtual resources received by the schedulers 120 using various selection strategies (e.g., a “water-fill” strategy that attempts to balance load across hosts 110, an “energy-saving” strategy that attempts to consolidate load on hosts 110 in a manner that provides energy savings, or the like, as well as various combinations thereof). For example, a scheduler 120 using a “water-fill” strategy may select, from the subset of hosts 110 determined to be candidates for serving a request for virtual resources received by the scheduler 120, one of the hosts 110 (from the subset of hosts 110) that is least loaded. For example, a scheduler 120 using an “energy-saving” strategy may select, from the subset of hosts 110 determined to be candidates for serving a request for virtual resources received by the scheduler 120, one of the hosts 110 (from the subset of hosts 110) that is already hosting virtual resources. For example, a scheduler 120 may select, from the subset of hosts 110 determined to be candidates for serving a request for virtual resources received by the scheduler 120, one of the hosts 110 (from the subset of hosts 110) that has the lowest associated latency. It will be appreciated that various other selection strategies may be used by schedulers 120 when selecting hosts 110 to serve requests for resources that are received by the schedulers 120, respectively. It will be appreciated that various combinations of state information of the hosts 110 may be considered by schedulers 120 when selecting hosts 110 to serve requests for resources that are received by the schedulers 120, respectively. It is noted that selection of a subset of hosts 110 as candidates to serve a request for virtual resources enables calculations, for selecting one of the hosts 110 to serve the request for virtual resources, to be performed on a subset of the state information (rather than on the state of all of the available hosts 110), thereby enabling faster decisions and parallelism without a significant impact on quality and performance. The schedulers 120 may be configured to support various other functions for selecting ones of the hosts 110 to serve requests for virtual resources received by the schedulers 120.

The schedulers 120 may initiate instantiation of the virtual resource on the selected one of the hosts 110 from the subset of hosts 110 selected to serve the request for the virtual resource. A scheduler 120 may initiate instantiation of the virtual resource on the selected one of the hosts 110 by interacting with the selected one of the hosts 110 to control instantiation of the virtual resource on the selected one of the hosts 110. A scheduler 120 may initiate instantiation of the virtual resource on the selected one of the hosts 110 by interacting with a controller to trigger the controller to interact with the selected one of the hosts 110 to control instantiation of the virtual resource on the selected one of the hosts 110 (e.g., by informing the controller of the one of the hosts 110 in the subset of hosts 110 selected by the scheduler 120). The schedulers 120 may initiate instantiation of the virtual resource on the selected one of the hosts 110 from the subset of hosts 110 selected to serve the request for the virtual resource in various other ways.

The schedulers 120, as indicated above, may interact with the hosts 110 at various points during the processing performed for assigning the requests for virtual resources to ones of the hosts 110 (e.g., for obtaining state information, instantiating virtual resources on the hosts 110, and so forth). The schedulers 120 may be configured with information which the schedulers 120 may use to communicate with the hosts 110 for such purposes. For example, the schedulers 120 may be configured with various communication parameters for any of the hosts 110 with which the schedulers 120 may need to communicate (e.g., host names, host addresses such as IP addresses, host port numbers, protocol information, or the like, as well as various combinations thereof). This configuration may be performed by a controller (which is omitted from FIG. 1 for purposes of clarity).

The schedulers 120 may be configured to handle virtual resource placement failure. A scheduler 120, upon failure of an attempt to serve a request for virtual resources by instantiating the virtual resource on a host 110, may give up or may try again. A scheduler 120 may give up after the first try, after a threshold number of tries, or the like. A scheduler 120 may try again using the same sample of candidate hosts 110, using a different sample of candidate hosts 110 having the same sample size (i.e., the same quantity of hosts 110 in the group of hosts 110), using a different sample of candidate hosts 110 having a larger sample size, using the full set of available hosts 110, or the like. It will be appreciated a scheduler may utilize multiple such retry embodiments in successive retries (e.g., first retrying with the same sample of candidate hosts 110, then retrying using a different sample of candidate hosts 110 having the same sample size, then retrying using a different sample of candidate hosts 110 having a larger sample size, and so forth). In at least some embodiments, the manner in which retries are performed may depend on the needs of the system. In at least some embodiments, the system may be configured in a manner that allows for most of the placement attempts to succeed if the resources allow it (e.g., 80% placement success rate, 90% placement success rate, or the like), so as to reduce or minimize the performance impact of retries. It will be appreciated that schedulers 120 may be configured to handle virtual resource placement failure in various other ways.

It will be appreciated, as indicated above, that various different aspects of the resource virtualization system 100 may be dynamic. For example, the number of hosts 110 may be modified dynamically. For example, the hosts 110 included in the subsets of hosts 110 for the schedulers 120 may be dynamic (e.g., schedulers 120 may consider different subsets of hosts 110 for different requests for virtual resources or different groups of requests for resources). For example, the numbers of hosts 110 in the subsets of hosts 110 for the schedulers 120 may be dynamic (e.g., the number of hosts 110 in the subset of hosts 110 for any given scheduler 120 may be increased or decreased dynamically, with or without changing the number of schedulers 120). For example, the number of schedulers 120 available for serving requests for virtual resources using the hosts 110 may be dynamic (e.g., the number of schedulers 120 available for serving requests for virtual resources using the hosts 110 may be increased or decreased dynamically, with or without changing the number of hosts 110 or the numbers of hosts 110 in the subsets of hosts 110 for the schedulers 120). It will be appreciated that various other aspects of the resource virtualization system 100 may be dynamic.

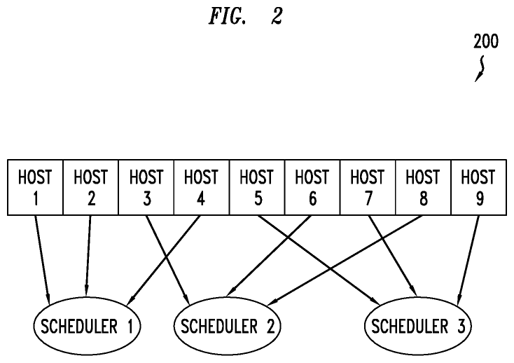

FIG. 2 depicts an example of a resource virtualization system configured to support virtual resources. The resource virtualization system 200 may be considered to be an example of the resource virtualization system 100 in which there are nine hosts 110 (N=9, where the hosts 110 are labeled using the format HOST-n, with n=1 . . . 9) and three schedulers 120 (K=3, where the schedulers 120 are labeled using the format SCHEDULER-k, with k=1 . . . 3). The resource virtualization system 200 is using mutually exclusive groups of hosts 110 for the schedulers 120, where the groups of hosts 110 for the schedulers 120 have a fixed group, or sample, size of three such that each of the three schedulers 120 is associated with three of the hosts 110 which may be used as candidates for selecting hosts 110 to service requests for virtual resources received by the schedulers 120, respectively. As depicted in FIG. 2, SCHEDULER-1 is associated with HOST-1, HOST-2, and HOST-4 (and may select one of these three hosts 110 to serve the next virtual resource request receive by the SCHEDULER-1), SCHEDULER-2 is associated with HOST-3, HOST-6, and HOST-8 (and may select one of these three hosts 110 to serve the next virtual resource request receive by the SCHEDULER-2), and SCHEDULER-3 is associated with HOST-5, HOST-7, and HOST-9 (and may select one of these three hosts 110 to serve the next virtual resource request receive by the SCHEDULER-3). It will be appreciated that the example of FIG. 2 represents merely one example of various ways in which hosts 110 may be associated with schedulers 120 for purposes of supporting virtual resource placement in response to virtual resource requests.

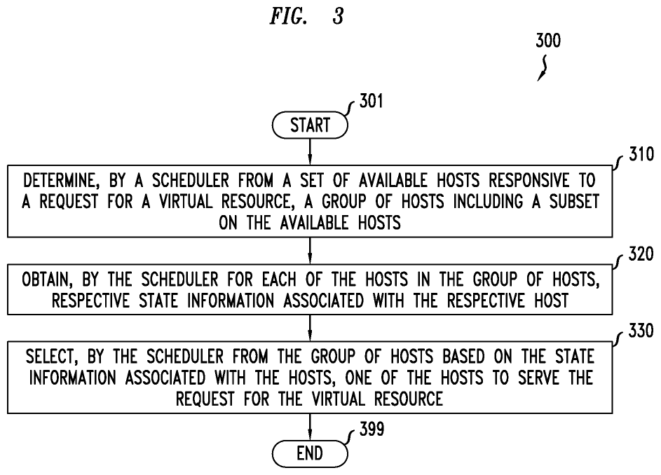

FIG. 3 depicts an example embodiment of a method for use by a scheduler to select a host to serve a request for a virtual resource. It will be appreciated that, although primarily presented as being performed serially, at least a portion of the functions of method 300 may be performed contemporaneously or in a different order than as presented with respect to FIG. 3. At block 301, method 300 begins. At block 310, determine, by a scheduler from a set of available hosts responsive to a request for a virtual resource, a group of hosts including a subset of the available hosts. At block 320, obtain, by the scheduler for each of the hosts in the group of hosts, respective state information associated with the respective host. At block 330, select, by the scheduler from the group of hosts based on the state information associated with the hosts, one of the hosts to serve the request for the virtual resource. At block 399, method 300 ends.

Various example embodiments for supporting placement of virtual resources in a resource virtualization system may provide various advantages or potential advantages. For example, various example embodiments for supporting placement of virtual resources in a resource virtualization system may support efficient allocation of virtual resources on virtualization hardware. For example, various example embodiments for supporting placement of virtual resources in a resource virtualization system may support allocation of virtual resources in a manner for improving or optimizing various aspects of placing virtual resources in a resource virtualization system (e.g., capacity, latency, utilization, energy consumption, virtual switching overhead, or the like, as well as various combinations thereof). For example, various example embodiments for supporting placement of virtual resources in a resource virtualization system may reduce or minimize various types of overhead which may be associated with serving requests for virtual resources (e.g., communication overhead associated with collecting state information from hosts, communication overhead associated with collecting state information from a cache or caches caching state information of the hosts, processing overhead associated with performing calculations on the full set of state information of all available hosts, or the like, as well as various combinations thereof). For example, various example embodiments for supporting placement of virtual resources in a resource virtualization system may reduce or minimize various types of system complexity which may be associated with serving requests for virtual resources (e.g., architectures attempting to synchronize cache state among schedulers). For example, various example embodiments for supporting placement of virtual resources in a resource virtualization system may maintain or improve placement efficiency, placement quality, scheduler performance, host performance, or the like, as well as various combinations thereof. For example, various example embodiments for supporting placement of virtual resources in a resource virtualization system may support scaling of the resource virtualization system (e.g., number of hosts supported) without sacrificing and perhaps while also improving various metrics (e.g., placement efficiency, placement quality, scheduler performance, host performance, or the like, as well as various combinations thereof). For example, various example embodiments for supporting placement of virtual resources in a resource virtualization system may obviate the need to use parallelism or periodic state caching which typically leave the per virtual resource overhead proportional to the number of hosts (although it will be appreciated that either of these strategies may be employed in various embodiments). For example, various example embodiments for supporting placement of virtual resources in a resource virtualization system may obviate the need to use hierarchical resource management which typically is inferior to flat resource management (although it will be appreciated that either type of management may be employed in various embodiments). For example, various example embodiments for supporting placement of virtual resources in a resource virtualization system may support parallelism (e.g., no synchronization is needed for schedulers that work on different samples), provably correct load balancing (e.g., in some cases, where the goal is load balancing, it can be formally proven that various embodiments are nearly optimal), scheduler simplification, constant placement overhead (e.g., supporting scale-up with the cloud size without increasing placement decisions overheads), or the like, as well as various combinations thereof. Various example embodiments for supporting placement of virtual resources in a resource virtualization system may provide various other advantages or potential advantages.

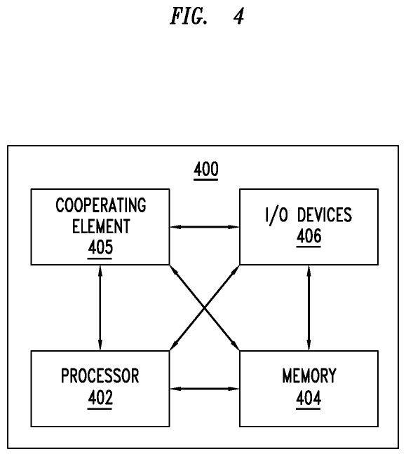

FIG. 4 depicts a high-level block diagram of a computer suitable for use in performing various functions described herein.

The computer 400 includes a processor 402 (e.g., a central processing unit, a processor having a set of processor cores, a processor core of a processor, or the like) and a memory 404 (e.g., a random access memory, a read only memory, or the like). The processor 402 and the memory 404 may be communicatively connected.

The computer 400 also may include a cooperating element 405. The cooperating element 405 may be a hardware device. The cooperating element 405 may be a process that can be loaded into the memory 404 and executed by the processor 402 to implement functions as discussed herein (in which case, for example, the cooperating element 405 (including associated data structures) can be stored on a non-transitory computer-readable storage medium, such as a storage device or other storage element (e.g., a magnetic drive, an optical drive, or the like)).

The computer 400 also may include one or more input/output devices 406. The input/output devices 406 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 400 may represent a general architecture and functionality suitable for implementing functional elements described herein, portions of functional elements described herein, or the like, as well as various combinations thereof. For example, computer 400 may provide a general architecture and functionality that is suitable for implementing one or more elements presented herein, such as a host 110 or a portion thereof, a scheduler 120 or a portion thereof, or the like, as well as various combinations thereof.

It will be appreciated that at least some of the functions presented herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits, and/or any other hardware equivalents).

It will be appreciated that at least some of the functions presented herein may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1-20. (canceled)

21. An apparatus, comprising:
at least one processor; and
at least one memory including computer program code;
wherein the at least one memory and the computer program code are configured to, with the at least one processor, cause the apparatus to at least:
determine, by a scheduler from a set of available hosts responsive to a request for a virtual resource, a group of hosts including a subset of the available hosts;
obtain, by the scheduler for each of the hosts in the group of hosts, respective state information associated with the respective host; and
select, by the scheduler from the group of hosts based on the state information associated with the hosts, one of the hosts to serve the request for the virtual resource.

22. The apparatus of claim 21, wherein the group of hosts is determined by the scheduler based on selection of the group of hosts by the scheduler.

23. The apparatus of claim 21, wherein the group of hosts is determined by the scheduler based on a message from a controller.

24. The apparatus of claim 21, wherein the group of hosts is a random subset of the available hosts.

25. The apparatus of claim 21, wherein a quantity of hosts in the group of hosts is based on a quantity of schedulers configured to operate on the set of available hosts.

26. The apparatus of claim 21, wherein a quantity of hosts in the group of hosts is based on a virtual resource placement success rate.

27. The apparatus of claim 21, wherein the group of hosts is mutually disjoint from a second group of hosts associated with a second scheduler.

28. The apparatus of claim 27, wherein the scheduler is configured to operate without synchronziation with the second scheduler.

29. The apparatus of claim 21, wherein the group of hosts at least partially overlaps a second group of hosts associated with a second scheduler.

30. The apparatus of claim 29, wherein the scheduler is configured to operate without synchronziation with the second scheduler.

31. The apparatus of claim 29, wherein the scheduler is configured to operate based on synchronization with the second scheduler in a manner for preventing the scheduler and the second scheduler from selecting a common host.

32. The apparatus of claim 21, wherein the one of the hosts selected to serve the request for the virtual resource is a least-loaded host in the group of hosts or a lowest-latency host in the group of hosts.

33. The apparatus of claim 21, wherein the at least one memory and the computer program code are configured to, with the at least one processor, cause the apparatus to at least:
initiate, by the scheduler, placement of the virtual resource on the one of the hosts selected to serve the request for the virtual resource.

34. The apparatus of claim 33, wherein, to initiate placement of the virtual resource on the one of the hosts selected to serve the request for the virtual resource, the at least one memory and the computer program code are configured to, with the at least one processor, cause the apparatus to at least:
send, by the scheduler toward the one of the hosts selected to serve the request for the virtual resource, a message requesting placement of the virtual resource on the one of the hosts selected to serve the request for the virtual resource.

35. The apparatus of claim 33, wherein, to initiate placement of the virtual resource on the one of the hosts selected to serve the request for the virtual resource, the at least one memory and the computer program code are configured to, with the at least one processor, cause the apparatus to at least:
send, by the scheduler toward a controller, a message requesting placement of the virtual resource on the one of the hosts selected to serve the request for the virtual resource.

36. The apparatus of claim 21, wherein the at least one memory and the computer program code are configured to, with the at least one processor, cause the apparatus to at least:
initiate, by the scheduler based on a determination that placement of the virtual resource on the one of the hosts selected to serve the request for the virtual resource is not successful, a new attempt to serve the request for the virtual resource.

37. The apparatus of claim 36, wherein the new attempt to serve the request for the virtual resource is based on one of the group of hosts, a new group of hosts having a size equal to a size of the group of hosts, or a new group of hosts having a size larger than a size of the group of hosts.

38. The apparatus of claim 21, wherein the virtual resource comprises a virtual machine or a virtual container.

39. A non-transitory computer-readable medium including instructions configured to cause an apparatus to at least:
determine, by a scheduler from a set of available hosts responsive to a request for a virtual resource, a group of hosts including a subset of the available hosts;
obtain, by the scheduler for each of the hosts in the group of hosts, respective state information associated with the respective host; and
select, by the scheduler from the group of hosts based on the state information associated with the hosts, one of the hosts to serve the request for the virtual resource.

40. A method, comprising:
determining, by a scheduler from a set of available hosts responsive to a request for a virtual resource, a group of hosts including a subset of the available hosts;
obtaining, by the scheduler for each of the hosts in the group of hosts, respective state information associated with the respective host; and
selecting, by the scheduler from the group of hosts based on the state information associated with the hosts, one of the hosts to serve the request for the virtual resource.
